(19) United States
(12) Patent Application Publication
(10) Pub. No.: US 2026/0021432 A1
(43) Pub. Date: Jan. 22, 2026

(54) Centrifugal Oil Separator, System, and Methods of Use

(71) Applicant: Westermeyer Industries Inc., Bluffs, IL (US)

(72) Inventors: Gary W. Westermeyer, Bluffs, IL (US); David Robert Frenk, Chatham, IL (US)

(21) Appl. No.: 19/270,828

(22) Filed: Jul. 16, 2025

Related U.S. Application Data
(60) Provisional application No. 63/672,480, filed on Jul. 17, 2024.

(51) Int. Cl. B01D 45/08; B01D 45/16; F25B 43/02

(52) U.S. Cl. CPC B01D 45/08; B01D 45/16; F25B 43/02

(57) ABSTRACT

An oil separator is described herein comprising a housing with first and second oil-gas separation sections and a lower oil reservoir. The second oil-gas separation section includes a bulk mesh portion that occupies a majority of the space between the inner wall of the housing and an outer wall of a central outlet tube for separated gas. An impingement plate is positioned between the second separation section and the oil reservoir section, and is configured to reduce gas turbulence in order to minimize oil re-entrainment into the gas. Related systems and methods also are disclosed.

### RELATED APPLICATIONS

This application claims the benefit of U.S. Provisional Patent Application No. 63/672,480 filed Jul. 17, 2024, the contents of which are incorporated by reference herein in their entirety.

### BACKGROUND

The use of carbon dioxide (CO2) as a refrigerant is becoming more prevalent, with a goal of replacing some conventional hydrocarbon (HFC, HCFC) based refrigerants due to claims that the conventional refrigerants contribute to global warming. The CO2 is required to function in a transcritical state for the refrigeration cycle to work efficiently. To operate within this gaseous state, the CO2 must be compressed to operating pressures that are on average 4 times the pressures of the conventional refrigerants.

Similar to conventional refrigerant cycles, the transcritical CO2 refrigeration circuit also relies on oil to lubricate the internal components of the compressor. During compression the oil vaporizes into the CO2 gas as it exits the compressor. To promote overall efficiency of the refrigeration system this oil must be returned to the compressor. If the oil were allowed to circulate around the entire circuit, it would degrade the rate of heat transfer within components critical to the overall system efficiency.

Oil separator designs are available within the refrigeration industry that depend upon internal filters. The oil collects on the surface of the filter with the gas being allowed to pass through to continue through the refrigeration circuit. After sufficient accumulation of oil on the surface, gravity will force the oil to the lower portion of the vessel. The filter designs may introduce high pressure drop as the gas flows through it due to the presence of larger particulates inherent within refrigeration cycles, contributing to overall energy losses in the refrigeration circuit. Conventional filter designs also require the filter to be replaced periodically, resulting in refrigeration system downtime.

It would be useful to develop oil separators for use in transcritical refrigeration systems that have improved efficiency.

### SUMMARY OF THE INVENTION

One embodiment described here is an oil separator comprising a housing having a tubular wall with an inner wall surface and an outer wall surface, an upper end closure and a lower end closure. The housing includes a first separation section comprising a tangential inlet adapted to receive an oil-gas mixture. The first separation section is configured to promote circular flow of the incoming oil-gas mixture, and has a layer of a first mesh portion formed on the inner surface of the wall of the housing configured to collect oil particles. The housing comprises a second separation section positioned below the first separation section. The second separation section is configured to collect additional oil particles. An oil reservoir section is positioned below the second separation section. The lower portion of the oil reservoir section includes an oil reservoir chamber configured to retain accumulated oil particles resulting in a liquid oil state, and an oil outlet.

A central tube extends axially within the housing through the first separation section and at least a portion of the second separation section. The central tube has an inner wall surface and an outer wall surface, a lower end portion, and an opposite upper end portion connected to a fluid outlet fitting, with at least one of the upper end portion and the fluid outlet fitting extending outwardly through the upper end closure of the housing. A second mesh portion occupies a majority of the space between the inner wall of the housing and an outer wall of the central tube in the second separation section. An impingement plate is positioned below the central tube and between the second separation section and the oil reservoir section. The impingement plate is configured to reduce gas turbulence in order to minimize oil re-entrainment into the gas.

Another embodiment is refrigeration system comprising a gas cooler configured to cool a gas while maintaining the temperature of the gas above a critical temperature for the gas, an evaporator downstream from the gas cooler, a compressor downstream from the evaporator, an oil separator configured to remove oil from a gas-oil stream exiting the compressor, and an oil conduit configured to return separated oil to the compressor. The oil separator comprises a housing with a first separation section, a second separation section and an oil reservoir chamber. The first separation section comprises a tangential inlet adapted to receive an oil-gas mixture, and is configured to promote circular flow of the incoming oil-gas mixture. The first separation section has a layer of a first mesh portion formed on an inner surface of the wall of the housing which is configured to collect oil particles. The second separation section is positioned below the first separation section and is configured to collect additional oil particles. The oil reservoir section is positioned below the second separation section. A central tube extends axially within the housing and is configured to remove separated gas from the oil-gas separator, which is subsequently fed to the gas cooler. A second mesh portion occupies a majority of the space between an inner wall of the housing and an outer wall of the central tube in the second separation section. An impingement plate is positioned below the central tube and between the second separation section and the oil reservoir section, and is configured to reduce gas turbulence in order to minimize oil re-entrainment into the gas. In embodiments, the system is a closed loop transcritical gas refrigeration system.

Another embodiment is an oil-gas separation method comprising obtaining an oil separator comprising a housing with a first separation section comprising a tangential inlet adapted to receive an oil-gas mixture and having a layer of a first mesh portion formed on an inner surface of the wall of the housing configured to collect oil particles, a second separation section positioned below the first separation section and being configured to collect additional oil particles, and an oil reservoir section positioned below the second separation section. A central tube extends axially within the housing and is configured to remove separated gas. A second mesh portion occupies a majority of the space between an inner wall of the housing an outer wall of the central tube in the second separation section. An impingement plate is positioned below the central tube and between the second separation section and the oil reservoir section. The method further includes introducing a first oil-gas mixture through the tangential inlet and removing a first portion of the oil from the gas in the first separation section due to circular flow of the incoming oil-gas mixture and the entrainment of oil on the first mesh portion, producing a second oil-gas mixture, introducing the second oil-gas mixture to the second separation section and removing a second portion of the oil from the gas due to passage of the second oil-gas mixture through the second mesh portion, producing a separated gas stream, collecting separated oil in the oil reservoir section, and removing the separated gas stream from the oil separator through the central gas outlet tube.

### BRIEF DESCRIPTION OF THE DRAWINGS

FIG. 1 shows one embodiment of a layout of a refrigeration system incorporating the oil separator of FIGS. 2-9.

FIG. 2 is a front view of a first embodiment of an oil separator.

FIG. 3 shows a top plan view of the first embodiment.

FIG. 4 shows a sectional view taken along line 4-4 of FIG. 3.

FIG. 5 depicts a sectional view taken along line 5-5 of FIG. 3.

FIG. 6 shows a cross-sectional view taken along line 6-6 of FIG. 2.

FIG. 7 depicts a cross-sectional view taken along line 7-7 of FIG. 2.

FIG. 8 shows an embodiment of the bulk mesh used in the first embodiment.

FIG. 9 shows a side sectional view of the upper end of the oil separator shown in FIG. 1.

FIG. 10 depicts a side sectional view of a second embodiment of an oil separator.

FIG. 11 is a cross-sectional view taken along line 11-11 of FIG. 10.

### DETAILED DESCRIPTION OF THE PREFERRED EMBODIMENTS

The embodiments described herein are configured for use in transcritical gas refrigeration systems, including but not limited to carbon dioxide (CO2) refrigeration systems. In transcritical CO2 refrigeration systems, the CO2 is cooled but not condensed at the outlet of the gas cooler, with the temperature of the fluid remaining above the critical temperature.

An oil separator for use in refrigeration systems, including transcritical refrigeration systems, is provided comprising a pressurized vessel having an internal geometry configured to direct a refrigerant gas containing an oil mist in a constantly changing direction to force gas and oil separation. The design of the separator relies upon both the centrifugal method and gravity to separate oil droplets from the gas. A primary design feature of the separator that leads to improved efficiency is the ability to achieve a lower pressure drop through the oil separator as compared to conventional systems while operating at higher pressures, including pressures associated with gases such as CO2. The benefit of the high pressure, lower pressure drop operation is that it results in lower energy costs to run the system.

In embodiments, the oil separator housing incorporates carbon steel construction capable of safely containing the higher operating pressures, and the housing has an internal geometry configured to promote separation of the oil from the CO2 gas.

A second stage of separation of the oil from the gas is effected by a bulk mesh located centrally within the vessel. The accumulation of oil particulates within the vessel results in further accumulation of liquid oil within the lower portion of the vessel. Ports or fittings communicating with an apparatus that uses oil and is external to the oil separating pressure vessel can be used to transport the accumulated oil to the apparatus from which it originated, or to another suitable location.

More specifically, the disclosed embodiments rely on high velocity gas entering a tangential inlet port of the pressurized vessel, where a constant change in direction inside the pressurized vessel results from following the internal curved layout of the pressurized vessel's boundary. This internal vessel boundary is covered with a thin mesh layer of screen material to help secure the oil mist where the gas is concentrated within this region due to its immediate direction upon entering the oil separator. The gas velocity, and therefore the mass flow, is higher on this peripheral edge than further inside the vessel. The higher concentration of gas flow saturated with oil particles results in continuous collisions of oil particles, resulting in accumulating oil droplets. The oil droplets that accumulate on the mesh layer surface flow downwardly due to gravity. This initial removal of the oil can be classified as the first stage and is a centrifugal separation that takes place in the first section of the oil separator.

A secondary stage of oil removal takes place further down axially in the vessel as the fluid stream impinges upon a bulk section of screen mesh that, in some cases, occupies substantially the entire internal portion of the vessel cylinder between the inner wall of the vessel and an outer wall of a central gas removal tube in a second separation section. This bulk screen mesh forms a second mesh portion that has a cylindrical shape, further promoting accumulation of oil particles that result in formation of liquid oil droplets. In embodiments, the second mesh portion comprises an annular roll formed by rolling up an elongated rectangular sheet to form a cylinder having a general shape of a paper towel roll, i.e. a hollow cylinder having an outer diameter corresponding to the inner diameter of the vessel, and having a central opening with a diameter corresponding to the outer diameter of the central tube. Gas flowing axially down the internal volume of the vessel forces oil droplets to accumulate in the lower portion of the vessel. Gas flow in a downward axial direction immediately turns about 180 degrees after exiting the second mesh portion, and the gas exits the separator at the upper end through a centrally positioned gas exit pipe. In embodiments, the second mesh portion rests upon a flow directing nozzle at the lower end of this outlet pipe. The flow directing nozzle is responsible for converging gas flow gradually, as abrupt gas converging to a smaller cross-sectional area would increase pressure drop and therefore would increase energy loss. In embodiments, the gas is CO2. While the description refers to a “gas stream” entering the oil separator, this term can be interpreted to include streams in which small quantities of the gas are in the form of a liquid, as may be the case with processes using transcritical fluids.

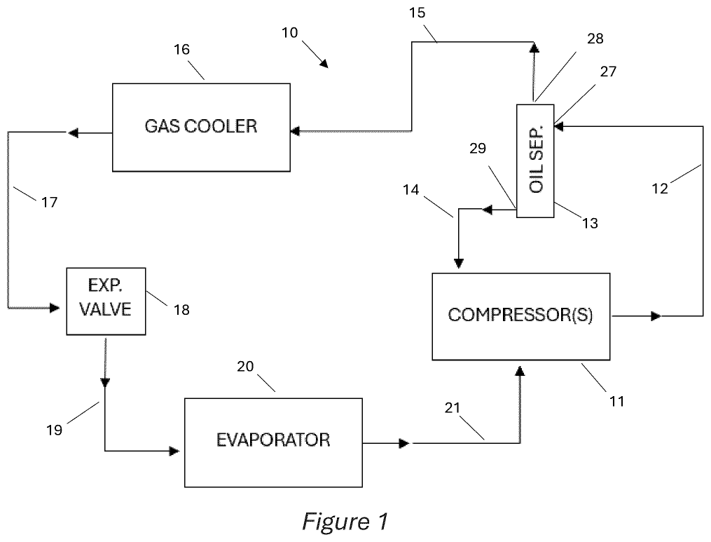

An embodiment of a closed loop transcritical gas refrigeration system is shown in FIG. 1 and is generally designated as 10. The system 10 includes a compressor 11 fluidly connected to an oil separator 13 by piping 12. The oil separator 13 includes a fluid inlet 27 that contains gas and oil, a fluid outlet 28 that contains refrigerant gas, and an oil outlet 29. The recovered oil remains in an oil reservoir chamber in the oil separator until a valve opens periodically to remove the oil. Oil removed from the gas in oil separator 13 is transported via an oil return line 14 to the compressor 11. Gas stripped of oil is directed to a gas cooler 16 by piping 15, and then routed to an expansion valve 18 through piping 17. Low pressure/low temperature refrigerant liquid is carried to the evaporator 20 by piping 19. The evaporator 20 is responsible for cooling the intended media (air or liquid), causing the liquidized gas to evaporate. The evaporated gas is then carried to the compressor 11 by piping 21 to repeat the cycle. In embodiments, the gas is CO2.

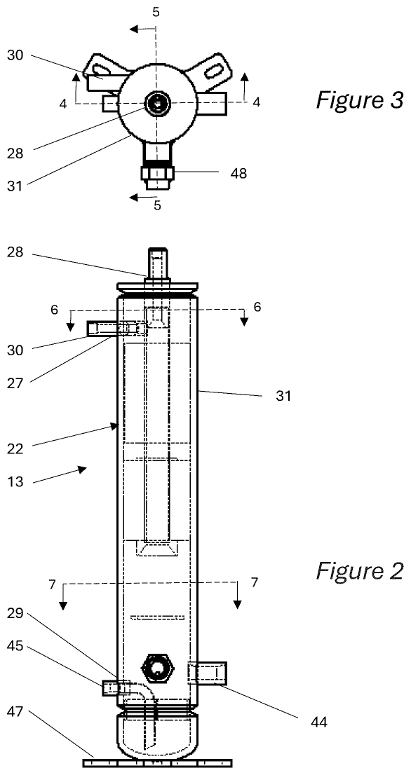

Details of the oil separator 13 are shown in FIGS. 2-9. The oil separator 13 can be a cyclone oil separator and comprises a pressurized vessel 22. The vessel 22 has a tubular side wall 31 including an inner wall surface 32 and an outer wall surface 26, an inlet fitting 30 which forms the fluid inlet 27, a fluid outlet fitting 38 which forms the fluid outlet 28, and an oil outlet fitting 45 for the oil outlet 29. Piping 12 is fixed to the inlet fitting 30 by a welding or brazing process. Piping 15 is similarly fixed to the fluid outlet fitting 38 and the oil outlet fitting 45.

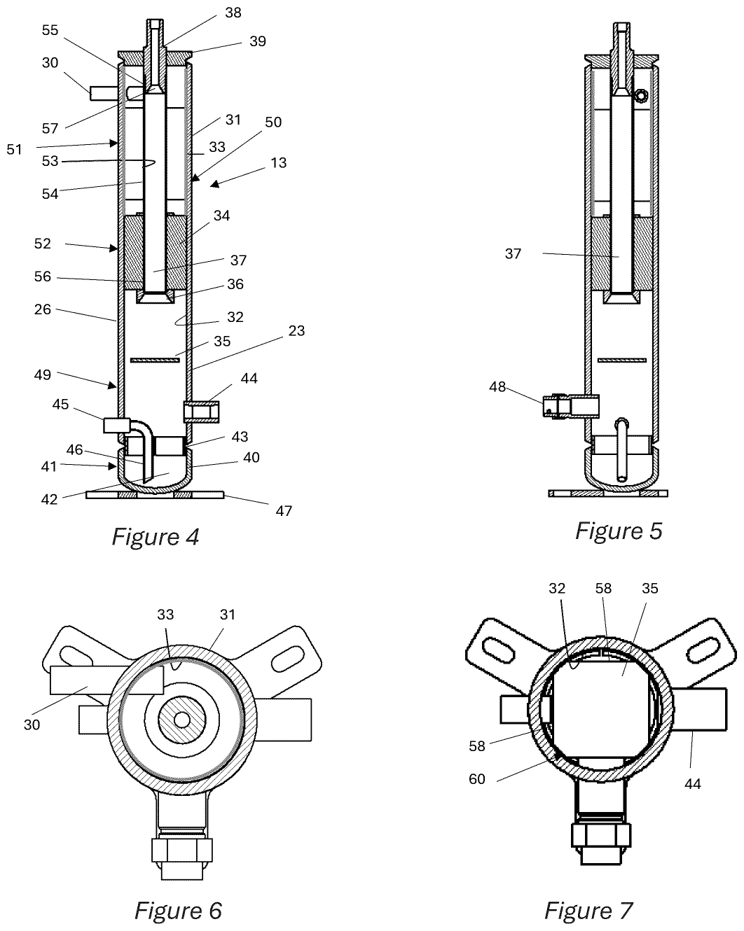

The high-pressure, high-temperature fluid, usually a transcritical fluid, which enters the oil separator 13 through the inlet fitting 30 is directed along vessel 22 inner wall surface 32 with a resulting circular flow pattern as it travels downwardly around the central axis of vessel 22. Mesh layer 33, which typically is a wire screen or another type of open mesh, is fixed to the inner wall surface 32 to collect oil removed from the gas while the gas is flowing in the circular pattern. The inlet fitting 30 is tangentially arranged as shown in FIGS. 3-4 to impart a swirling action, impinging the oil and gas mixture by centrifugal force against and through the mesh layer 33 that is disposed on the inner wall surface 32 of the vessel 22. In the embodiment shown in FIGS. 2-9, the mesh layer 33 extends downwardly through most or all of the length of the first separation section 51.

Following the interaction with mesh layer 33, the centrifugal gas encounters a second separation section 52 containing a bulk mesh 34, which can be formed from a wire screen or the like that occupies a majority of the volume between a central tube 37 and the inner wall surface 32 of the vessel 22 when viewed from above, and between the lower end of the first separation section 51 and the lower end of the central tube 37 when viewed from the side. The central tube 37, which has an inner wall surface 53, an outer wall surface 54, an upper end portion 55 and a lower end portion 56, serves as the fluid outlet for the separated gas. In embodiments, the bulk mesh 34 occupies about 80% to about 100% of the cross sectional area of the space between the inner wall 32 of the housing 23 and the outer wall 54 of the central tube 37 when viewed from above, and is formed by rolling a flat screen material. In the embodiment shown in FIGS. 2-9, the bulk mesh 34 is generally shaped as a hollow cylinder with an outer perimeter 64 and a longitudinal central opening having an inner perimeter 62. In embodiments, the bulk mesh 34 is slightly deformable such that it can conform to the shape and size of the annular opening between the inner wall surface 32 of the vessel 22 and the outer wall surface 54 of the central tube 37. When the bulk mesh 34 is formed from a rolled screen-type material, the thickness range of the unrolled (flat) version of the bulk mesh 34 typically is about 0.125 inches to about 0.3 inches, or about 0.2 inches to about 0.25 inches. The mesh is cut and rolled as needed to meet the required dimensions. The bulk mesh alternatively can be permanently formed in the annular shape in which it is used.

An impingement plate 35 is fixed to the inner wall surface 32 at two, three, four or more attachment points 60 (see FIG. 7, which shows four attachment points) allowing oil to flow downwardly in the space between the edges 58 of plate 35 and the inner wall surface 32 between the points of fixation. The volume above plate 35 is the oil separation chamber 50, whereas the volume below plate 35 is the oil reservoir section 49 including an oil reservoir chamber 42 at the lower end thereof. Impingement plate 35 reduces gas turbulence in oil reservoir chamber 42 to minimize oil re-entrainment into the CO2 gas flow. The impingement plate 35 usually is attached to the vessel internal wall at four points symmetrically about the center axis. The plate can be generally rectangular and is flat to not promote further flow beyond its perimeter to the oil reservoir below, whereas other prior art is of a curved form downward that could promote gas flow beyond its occupied region. In embodiments, the impingement plate 35 occupies about 80-90%, or about 85%-90% of the cross-sectional area of the vessel space, thereby keeping most of the gas out of the oil reservoir section 49 while allowing oil to flow downwardly into the oil reservoir section 49.

Oil accumulates in the lower end portion 41 of the oil reservoir section 49 of the vessel 22 in an oil reservoir chamber 42. The oil reservoir section 49 is formed by the lower portion of the inside wall surface 32 of the vessel 22, the lower wall surface of the impingement plate 35, and a lower end closure 40, such as a pipe cap, which, in some cases, is fixed to the lower end of the vessel 22 by a weld and a backing ring 43. Oil chamber fitting 44, shown in FIGS. 2-9, optionally can be included to accommodate accessories for oil level monitoring. The oil level may be viewed through optional sight port 48. Oil exits the vessel 22 through dip tube 46 attached to oil outlet fitting 45. In embodiments, a valve opens at certain intervals to remove oil. The oil outlet fitting 45 is attached to oil return line 14 which returns the separated oil to the compressor 11. The vessel 22 can be mounted on support plate 47 during final installation.

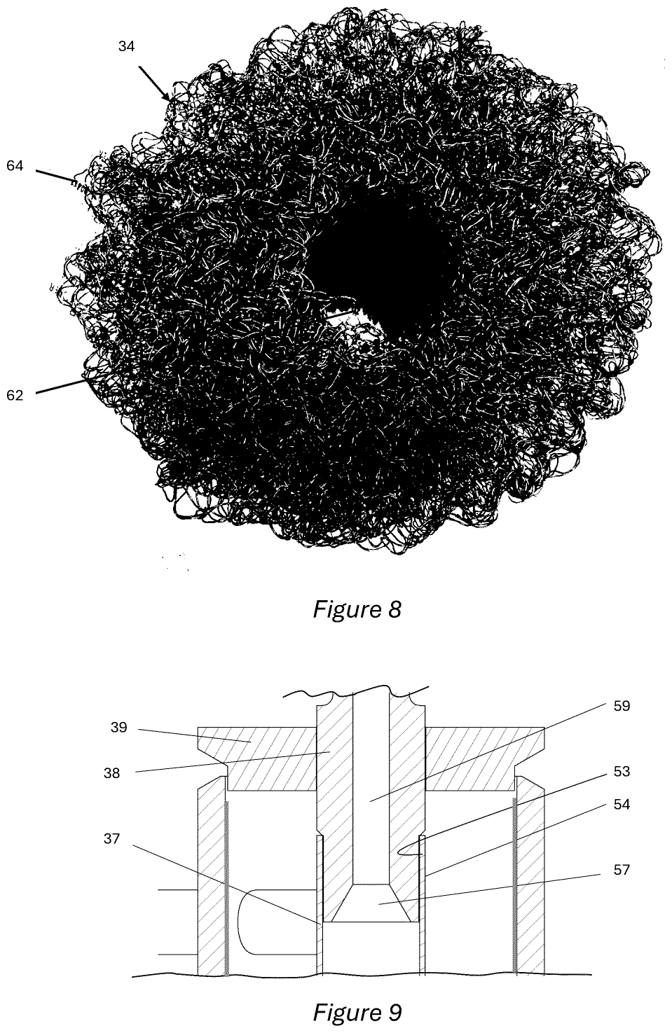

The impingement plate 35 aids in directing gas flow to and through the central tube 37. In embodiments, the inlet end of the central tube 37 has a converging nozzle comprising a first flow directing reducer 36 with a downstream end having an inner diameter corresponding to the inner diameter of the central tube 37 and an upstream end with a larger diameter. The first flow directing reducer 36 assists in providing for gas to enter the central tube 37. The outlet end of the central tube 37 is attached to the fluid outlet fitting 38. The outlet end of the fluid outlet fitting 38 is attached to pipe 15, which transports gas to the gas cooler 16. In embodiments, the fluid outlet fitting 38 incorporates a converging nozzle 57 to minimize pressure drop or energy loss. In the embodiment shown in FIGS. 2-9, the central tube 37 and the fluid outlet fitting 38 are formed as separate components, but in embodiments the fluid outlet fitting could be integrally formed with the central tube 37. In the embodiment shown in FIGS. 2-9, the first flow directing reducer 36 has an additional function of physically supporting the bulk mesh 34 in place in the vessel 22. (This support acts in combination with the downwardly flowing gas to hold the bulk mesh 34 in place.) In many cases, the bulk mesh 34 is also supported by being dimensioned to be held in place by a friction fit. When the bulk mesh 34 is rolled, it can be held in a roll shape by one or more fasteners, and can be manually inserted in the vessel 22 by squeezing it slightly and then releasing it at the desired location. In the embodiment shown in FIG. 8 the fastener is a long U-shaped clip that is internal to the mesh.

The upper end of the fluid outlet fitting 38 may be fixed by welding to the upper end closure 39 (shown as a generally flat plate in FIGS. 2-9), which can be welded to the upper end of vessel 22 and serves as the top of the vessel 22. In the embodiment shown in FIGS. 2-9, the converging nozzle 57 is connected to the upper end of central tube 37. The converging nozzle 57 further reduces the cross sectional area for gas flow from the fluid outlet 28 through narrower outlet 59.

In embodiments, reducer 36 reduces the cross-sectional area from its inlet end to its outlet end from about 25% to about 45%, or about 30% to about 40%. In embodiments, converging nozzle 57 reduces the cross sectional from its inlet end to its outlet end by about 25% to about 45%, or about 30% to about 40%.

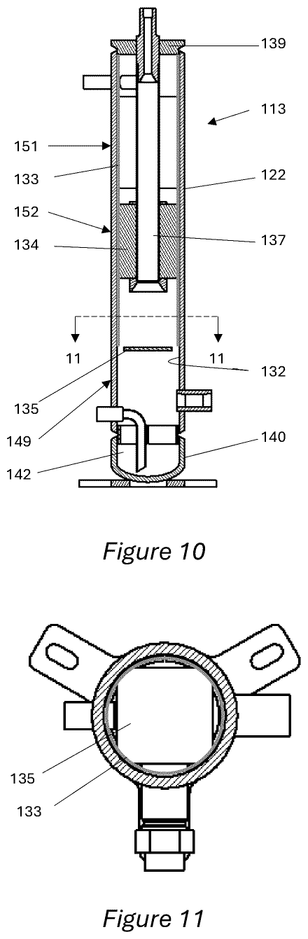

A second embodiment of an oil separator is shown in FIGS. 10-11 and is generally designated as 113. In this embodiment, a mesh layer 133 is formed on the inner wall surface 132 of pressurized vessel 122 and extends from an upper end point adjacent to the upper end closure 139 of the inner wall surface 132 down to the vertical level of the impingement plate 135. The mesh layer 133 is included in the first separation section 151, the second separation section 152 and between the lower end of the central tube 137 and the impingement plate 135. The inclusion of the mesh layer 133 below the bulk mesh 134 provides for additional surface area on which oil particles can be retained before they move downwardly by gravity into an oil reservoir chamber 142 in an oil reservoir section 149 near the lower end closure 140 as the gas changes direction to move upwardly through central tube 137. In another embodiment (not shown) the mesh layer includes two separate sections, with one section being above the bulk mesh 134 and the other being below the bulk mesh and above the impingement plate.

In embodiments, the housing 23 has a tubular wall with a length in the range of about 7 inches to about 30 inches, or about 8 inches to about 26 inches, or about 12 inches to about 24 inches. The housing typically has an inner diameter of about 3 inches to about 6 inches, or about 3.5 inches to about 5.75 inches, and a tubular wall thickness in the range of about 0.06 inches to about 0.18 inches, or about 0.07 inches to about 0.16 inches, or about 0.09 inches to about 0.15 inches. The ratio of the length of the housing to the inner diameter of the housing typically is in the range of about 3:1 to about 4:1.

The first separation section 51 typically has a length in the range of about 5 inches to about 26 inches, or about 6 inches to about 22 inches, or about 8 inches to about 20 inches, with the length depending on operating parameters and vessel size. The vertical dimension of the bulk mesh 34 also will depend on operating parameter and vessel size, but typically is in the range of about 3 inches to about 12 inches, or about 4 inches to about 10 inches, or about 5 inches to about 8 inches for an oil separator having an internal height of about 8 to about 20 inches. Thus, in many cases the ratio of the height of the mesh to the height of the vessel typically is in the range of about 4:1 to about 7:1, or about 5:1 to about 7:1. The ratio of the height of the first separation section 51 to the height of the bulk mesh 34 in the second separation section typically is in the range of about 2:3 to about 1:4.

In embodiments, the internal geometries and volumes of the oil separator 13 are selected to present an overall pressure drop depending on flow rate to remain less than about 10 psi, or less than about 8 psi, or less than about 6 psi. For CO2, a conventional separator that utilizes a filter element (coalescing), typically has a pressure drop of 5-15 psi. With the embodiments of the separator disclosed herein, the system can be designed such that the pressure drop is typically in the range of 2-6 psi, or 3-5 psi, resulting in better efficiency than conventional systems. Taking into account the high operating pressures of, for example 1600 psi, 1800 psi and 2000 psi, pressure drops of only 2-6 psi are calculated to be a pressure drop of only about 0.1% to about 0.4%. When the gas is CO2, operating temperatures for the operating pressures of 1600-2000 psi typically are in the range of about 250 Deg. F to about 300 Deg. F.

Systems operating in warmer climates typically have increased operating temperatures and pressures as compared to comparable systems operating in cooler climates. The oil discharge rate from some compressors can increase at higher operating temperatures and pressures. The disclosed embodiments function well in warmer climates in that they can accommodate these higher oil discharge rates. In contrast, in some cases conventional coalescing filters become quickly saturated with oil. With conventional systems, this saturated state reduces gas flow, causing a higher pressure drop and resulting in more energy usage by the compressor to overcome this pressure drop (energy loss).

Computational fluid dynamics can be utilized to determine the equipment and operating parameters to achieve the desired pressure drop. For an oil separator having the dimensions provided above, if the system is operated at a pressure in the range of 1600 PSIG to 2000 PSIG using CO2 gas, pressure drops in the range of about 2 to about 6 PSI, or about 2 PSI to about 5 PSI, or about 2 PSI to about 4.5 PSI can be obtained.

The pressurized vessel 22 has a wall thickness to render it suitable for high internal pressures and temperatures. In embodiments, the vessel tubular side wall 31 is made of metal, such as steel, for examples carbon steel. The inner wall surface 32 is curved and usually has a circular cross section in order to promote circular flow of the incoming oil-gas mixture.

The vessel 22 is configured to separate refrigerants that can operate at a transcritical range from oil. Non-limiting examples of suitable refrigerants include carbon dioxide (R-744) refrigerant. CO2 may require pressures in the oil separator to run in the range of 1000 PSIG to 2000 PSIG, or 1000 PSIG to 1900 PSIG, or 1050 PSIG to 1700 PSIG. This is contrasted with pressures of oil separators using refrigerants which operate at, for example, 200 PSIG to 400 PSIG. CO2 is particularly useful in cold temperature conditions, such as in the range of −30 to −50 Deg. C, because there are small reductions in saturation temperature for a given pressure drop. The critical point of CO2 is 7.3773 MPa (1070 psi)—above that point it cannot be liquidized. The critical temperature of CO2 is approximately 31° C. (87° F.).

The mesh layer 33 that lines the inner wall surface 32 of the vessel 31 typically is made of a metal, such as steel, but alternatively can be formed from durable composites and the like that can withstand the operating temperatures and pressures of the vessel without deforming. This mesh usually is in the range of 300 to 400 holes per square inch.

The bulk mesh 34 disposed in the second separation section 52 typically is made of a metal, such as steel, but alternatively can be formed from any durable mesh material that can withstand the high temperatures and pressures of the system. This mesh usually has a size in the range of about 25 to about 60 holes per square inch, or about 30 to about 50 holes per square inch.

A number of alternatives, modifications, variations, or improvements therein may be subsequently made by those skilled in the art, which are also intended to be encompassed by the following claims.

What is claimed is:

1. An oil separator, comprising:
a housing having a tubular wall with an inner wall surface and an outer wall surface, an upper end closure and a lower end closure, the housing including:
a first separation section comprising a tangential inlet adapted to receive an oil-gas mixture, the first separation section being configured to promote circular flow of the incoming oil-gas mixture, and having a layer of a first mesh portion formed on the inner surface of the wall of the housing configured to collect oil particles, and
a second separation section positioned below the first separation section, the second separation section being configured to collect additional oil particles,
an oil reservoir section positioned below the second separation section, the oil reservoir section including an oil reservoir chamber configured to retain accumulated oil particles, and an oil outlet,
a central tube extending axially within the housing through the first separation section and at least a portion of the second separation section, the central tube having an inner wall surface and an outer wall surface, a lower end portion, and an opposite upper end portion connected to a fluid outlet fitting, at least one of the upper end portion and the fluid outlet fitting extending outwardly through the upper end closure of the housing,
a second mesh portion that occupies a majority of the space between the inner wall of the housing and an outer wall of the central tube in the second separation section, and
an impingement plate positioned below the central tube and between the second separation section and the oil reservoir section, the impingement plate being configured to reduce gas turbulence in order to minimize oil re-entrainment into the gas.

2. The oil separator of claim 1, wherein the impingement plate has a plurality of connection points to the inner wall of the housing and defines a plurality of openings between the second separation section and the oil reservoir section along the inner wall surface of the housing.

3. The oil separator of claim 1, wherein the impingement plate is generally planar.

4. The oil separator of claim 1, wherein the impingement plate is generally rectangular.

5. The oil separator of claim 1, wherein the second mesh portion has an annular configuration.

6. The oil separator of claim 1, further comprising a first reducer formed on the lower end portion of the central tube.

7. The oil separator of claim 1, wherein at least one of the upper end portion of the central tube and the fluid outlet fitting has a second reducer formed thereon.

8. The oil separator of claim 1, wherein the housing is configured to withstand internal gas pressures of up to 1800 PSIG.

9. The oil separator of claim 1, wherein the housing is configured to process oil-gas mixtures having a temperature of up to about 300 Deg. F.

10. The oil separator of claim 1, wherein the housing is configured to separate carbon dioxide from oil.

11. The oil separator of claim 1, wherein the housing is formed from carbon steel.

12. The oil separator of claim 1, wherein the second mesh portion comprises a cylinder with a central bore.

13. The oil separator of claim 1, wherein the second mesh portion has a height in the range of about 3 inches to about 4 inches.

14. The oil separator of claim 1, wherein the central tube and the fluid outlet fitting are formed as a unitary component.

15. A refrigeration system, comprising:
a gas cooler configured to cool a gas while maintaining the temperature of the gas above a critical temperature for the gas,
an evaporator downstream from the gas cooler,
a compressor downstream from the evaporator,
an oil separator configured to remove oil from a gas-oil stream exiting the compressor, and
an oil conduit configured to return separated oil to the compressor,
the oil separator comprising:
a housing with a first separation section comprising a tangential inlet adapted to receive an oil-gas mixture, the first separation section being configured to promote circular flow of the incoming oil-gas mixture, and having a layer of a first mesh portion formed on an inner surface of the wall of the housing configured to collect oil particles, a second separation section positioned below the first separation section and being configured to collect additional oil particles, and an oil reservoir section positioned below the second separation section,
a central tube extending axially within the housing configured to remove separated gas from the oil-gas separator, which is subsequently fed to the gas cooler,
a second mesh portion that occupies a majority of the space between an inner wall of the housing and an outer wall of the central tube in the second separation section, and
an impingement plate positioned below the central tube and between the second separation section and the oil reservoir section, the impingement plate being configured to reduce gas turbulence in order to minimize oil re-entrainment into the gas,
the system being a closed loop transcritical gas refrigeration system.

16. The refrigeration system of claim 15, wherein the system is configured to use a gas comprising carbon dioxide.

17. A method, comprising:
obtaining an oil separator comprising:
a housing including a first separation section comprising a tangential inlet adapted to receive an oil-gas mixture and having a layer of a first mesh portion formed on an inner surface of a wall of the housing configured to collect oil particles, a second separation section positioned below the first separation section and being configured to collect additional oil particles, and an oil reservoir section positioned below the second separation section,
a central gas outlet tube axially disposed in the housing,
a second mesh portion that occupies a majority of the space between an inner wall of the housing and an outer wall of the central gas outlet tube in the second separation section, and
an impingement plate positioned below the central tube and between the second separation section and the oil reservoir section,
introducing a first oil-gas mixture through the tangential inlet and removing a first portion of the oil from the gas in the first separation section due to circular flow of the incoming oil-gas mixture and the entrainment of oil on the first mesh portion, producing a second oil-gas mixture,
introducing the second oil-gas mixture to the second separation section and removing a second portion of the oil from the gas due to passage of the second oil-gas mixture through the second mesh portion, producing a separated gas stream,
collecting separated oil in the oil reservoir section, and
removing the separated gas stream from the oil separator through the central gas outlet tube.

18. The method of claim 17, wherein the gas comprises carbon dioxide.

19. The method of claim 17, wherein the separated gas stream passes through a first reducer when entering the central tube.

20. The method of claim 17, wherein the oil separator is operated at a pressure in the range of about 1000 PSIG to about 1800 PSIG and a pressure drop in the range of about 2 PSI to about 8 PSI.
